(19) United States
(12) Patent Application Publication
(10) Pub. No.: US 2012/0081498 A1
(43) Pub. Date: Apr. 5, 2012

(54) LIGHT-EMITTING PANEL, OPTICAL PRINT HEAD AND IMAGE FORMING APPARATUS

(75) Inventors: Daisuke Ishikawa, Shizuoka-ken (JP); Koji Tanimoto, Shizuoka-ken (JP); Kenichi Komiya, Kanagawa-ken (JP); Kazutoshi Takahashi, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/245,656

(22) Filed: Sep. 26, 2011

Related U.S. Application Data
(60) Provisional application No. 61/389,705, filed on Oct. 4, 2010.

(51) Int. Cl. B41J 2/47; F21V 21/00; G03G 15/04

(52) U.S. Cl. 347/225; 399/220; 362/249.01

(57) ABSTRACT

Generally, according to an embodiment, a light-emitting panel includes a substrate and a light-emitting unit. The substrate is extended in a first direction. The light-emitting units are a plurality of light-emitting units that is in line in the first direction and comprises a light-emitting surface of which a length of a second direction that is orthogonal to the first direction is shorter than a length of the first direction.

### CROSS-REFERENCE TO RELATED APPLICATION

This application is based upon and claims the benefit of priority from U.S. provisional application 61/389,705, filed on Oct. 4, 2010; the entire contents of which are incorporated herein by reference.

### FIELD

Exemplary embodiments relate to a light-emitting panel, an optical print head and an image forming apparatus.

### BACKGROUND

In the related art, an image forming apparatus such as a MFP (Multi Function Peripheral) or the like includes an optical print head that exposes a photoconductive drum for each line in a main scanning direction. The optical print head includes a plurality of light-emitting units that is in line in the main scanning direction. Light that is emitted from each of light-emitting units is condensed onto the photoconductive drum as a spot light and exposes the photoconductive drum. At the photoconductive drum, in order to obtain a good image quality, it is desirable that an exposure shape that is a shape of an area exposed by the spotlight be a square shape or a circular shape. Accordingly, in the related art, in an optical print head, the shape of a light-emitting surface of each of light-emitting units is mostly the square shape or the circular shape such that the exposure shape is an ideal shape.

However, the photoconductive drum rotates while the light-emitting unit exposes the photoconductive drum. Thus, in the optical print head of the related art, even though the light-emitting surface of the light-emitting unit is a square shape, the exposure shape is a rectangular shape that is extended in a sub scanning direction that is a rotation direction of the photoconductive drum such that it is not desirable from the point of image quality.

### DESCRIPTION OF THE DRAWINGS

FIG. 1 is a drawing illustrating an interior structure of an image forming apparatus.

FIG. 2 is a cross sectional view illustrating an optical print head.

FIG. 3 is a perspective view illustrating a light-emitting panel.

FIG. 4 is a drawing illustrating a configuration of a control unit of the image forming apparatus.

FIG. 5 is a drawing illustrating a shape of a light-emitting surface.

FIG. 6 is a drawing illustrating a photoconductive drum that is exposed by the light-emitting surface.

FIG. 7 is a drawing illustrating a shape of an exposed area when the photoconductive drum is stopped.

FIG. 8 is a drawing illustrating a shape of a practical exposed area.

FIG. 9 is a drawing illustrating a shape of a light-emitting surface.

FIG. 10 is a drawing illustrating a shape of an exposed area.

FIG. 11 is a plan view illustrating a light-emitting panel.

### DETAILED DESCRIPTION

Generally, according to embodiments, a light-emitting panel includes a substrate and light-emitting units. The substrate is extended in a first direction. The light-emitting units are a plurality of light-emitting units that is in line in the first direction on the substrate. The light-emitting unit has a light-emitting surface of which a length of a second direction that is orthogonal to the first direction is shorter than a length of the first direction.

Generally, according to embodiments, an image forming apparatus includes a substrate, a light-emitting unit, a lens array, a photoconductor and a developing unit. The substrate is extended in a first direction. The light-emitting units are a plurality of light-emitting units that is in line in the first direction on the substrate. The light-emitting unit has a light-emitting surface of which a length of a second direction that is orthogonal to the first direction is shorter than the length of the first direction. The lens array guides light that is emitted from each of the light-emitting units to an exposure position. Light that is emitted from the light-emitting unit exposes the photoconductor. The developing unit supplies toner to the photoconductor and forms a toner image onto the photoconductor.

Hereinafter, each of embodiments will be described with reference to drawings.

### First Embodiment

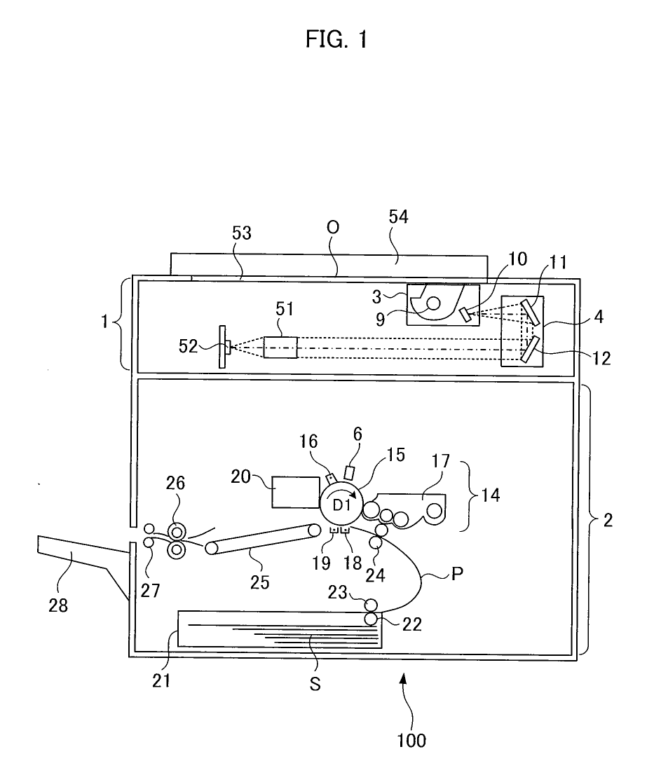

FIG. 1 is a drawing illustrating an interior structure of an image forming apparatus 100.

In a scanner unit 1 of the image forming apparatus 100, a first carriage 3 that supports a light source 9 and a mirror 10, and a second carriage 4 that supports mirrors 11 and 12 are moved independently to each other in a left and right direction in FIG. 1 and constantly maintain an optical path length thereof from an original document O to a photoelectric conversion element 52. The original document O is loaded on a transparent document table 53. A cover 54 is used for fixing the original document O on the document table 53. Light that is emitted from the light source 9 is reflected on the original document O and then forms an image on the photoelectric conversion element 52 through the mirrors 10, 11 and 12, and a condensing lens 51. The photoelectric conversion element 52 outputs image data to an optical print head 6 of a printer unit 2. The scanner unit 1 reads the image of the original document O for each line in a vertical direction of the paper of FIG. 1.

In the printer unit 2, sheet S within a sheet feeding cassette 21 is transported to an image forming unit 14 via a sheet feeding roller 22, a separation roller 23, a transportation passage P and a resist roller 24. A photoconductive drum 15 of the image forming unit 14 rotates in a direction of an arrow D1. A charger 16 charges a surface of the photoconductive drum 15. The optical print head 6 scans on the photoconductive drum 15 in a main scanning direction (the vertical direction of the paper of FIG. 1) and forms an electrostatic latent image on the photoconductive drum 15. A developing unit 17 supplies toner to the photoconductive drum 15, develops the electrostatic latent image and forms a toner image on the photoconductive drum 15. The image forming unit 14 includes a transfer charger 18, a separating charger 19 and a cleaner 20, and transfers the toner image of the photoconductive drum 15 on the sheet S. A conveying mechanism 25 transports the sheet S to a fixing unit 26, the sheet S is heated and pressed at the fixing unit 26, and then a discharge roller 27 discharges the sheet S onto a discharge tray 28. In addition, the photoconductive drum 15 may not directly transfer the toner image to the sheet S and may indirectly transfer the toner image to the sheet S through a intermediate transfer belt.

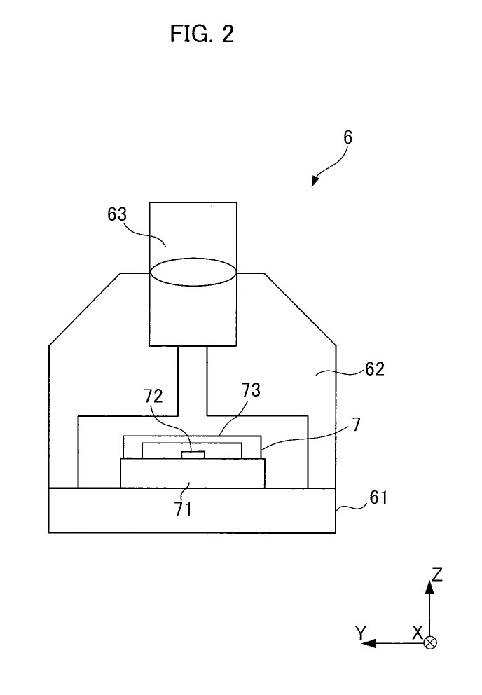

FIG. 2 is a cross sectional view illustrating the optical print head 6. X, Y and Z axes are orthogonal to each other in FIG. 2.

The optical print head 6 is extended in a rear direction of the paper of FIG. 2. The optical print head 6 emits light for every 1 line and exposes the photoconductive drum 15 for each line. The optical print head 6 includes an attachment base 61, a lens holder 62, a SELFOC lens array 63 and a light-emitting panel 7. The attachment base 61 retains the light-emitting panel 7. The light-emitting panel 7 includes a plurality of light-emitting units 72 in line in the rear direction of the paper of FIG. 2. The lens holder 62 retains the SELFOC lens array 63 and positions the SELFOC lens array 63 with respect to the light-emitting panel 7. The SELFOC lens array 63 includes a plurality of SELFOC lens corresponding to each of light-emitting units 72 in line in the rear direction of the paper of FIG. 2. The SELFOC lens array 63 forms an image of light of each of the light-emitting units 72 with each SELFOC lens as a spotlight having a required resolution on the photoconductive drum 15.

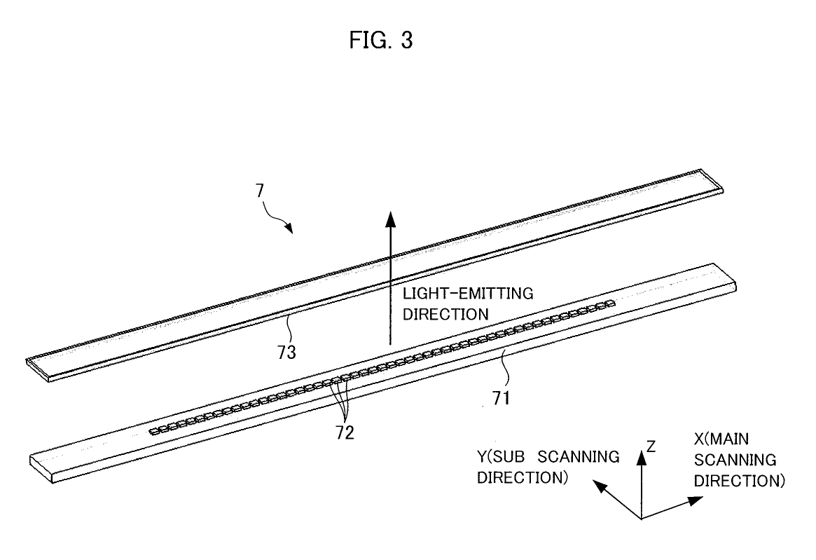

FIG. 3 is a perspective view illustrating the light-emitting panel 7.

The light-emitting panel 7 includes a glass substrate 71, the light-emitting units 72 and a sealing panel 73.

The glass substrate 71 is a longitudinal-shape and is formed from transparent glass through which light penetrates.

The sealing panel 73 covers the light-emitting units 72 and the light-emitting units 72 are sealed between the glass substrate 71 and the sealing panel 73.

The plurality of light-emitting units 72 is continuously provided on the glass substrate 71 in a row in the main scanning direction (the longitudinal direction of the glass substrate 71). The light-emitting unit 72 has Organic Electro Luminescence. The light that is emitted from the light-emitting unit 72 penetrates the sealing panel 73 and directs to the SELFOC lens array 63.

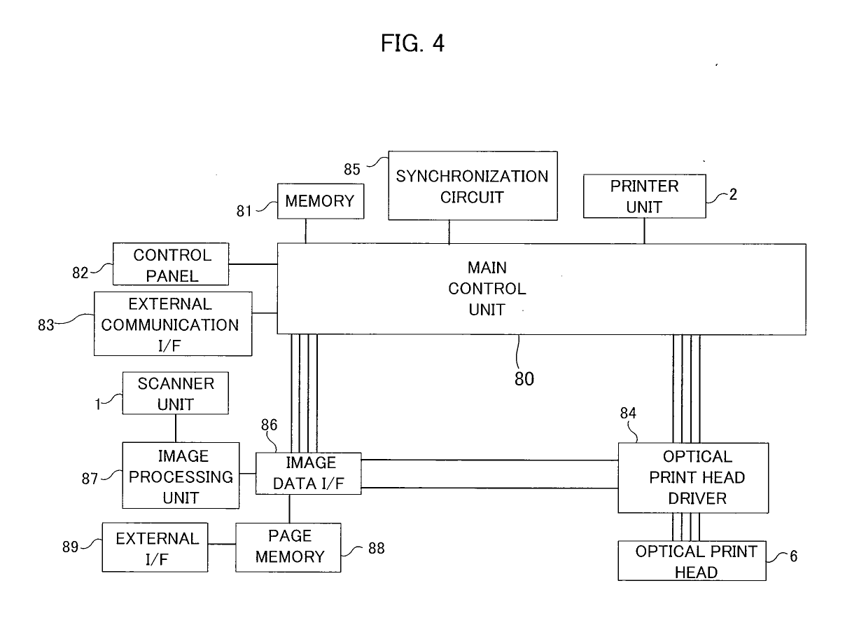

FIG. 4 is a drawing illustrating a configuration of a control unit of the image forming apparatus 100.

A main control unit 80 is a CPU and controls the entire image forming apparatus 100. A memory 81, a control panel 82, an external communication I/F 83, an optical print head driver 84, a synchronization circuit 85 and an image data I/F 86 are connected to the main control unit 80. An image processing unit 87 and a page memory 88 are connected to the image data I/F 86. The scanner unit 1 is connected to the image processing unit 87 and an external I/F 89 is connected to the page memory 88. The scanner unit 1 reads the image of the original document 0 and outputs the image data to the image processing unit 87. The image data is subjected to shading correction at the image processing unit 87 and then is transported to the image data I/F 86. The image data I/F 86 transports the image data to the main control unit 80 and transport the image data from the main control unit 80 to the optical print head driver 84 in synchronization with a clock that is generated by the synchronization circuit 85.

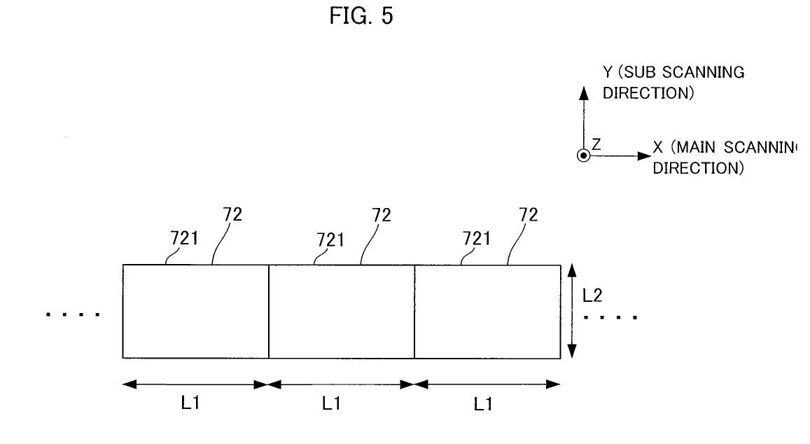

FIG. 5 is a drawing illustrating a shape of a light-emitting surface 721 of the light-emitting unit 72.

The light-emitting surface 721 that emits the light has a rectangular shape that extends to the main scanning direction (a first direction) in each of the light-emitting units 72. In other words, the light-emitting surface 721 has a flat rectangular shape in a sub scanning direction wherein a length L2 in the sub scanning direction (a second direction) is shorter than a length L1 in the main scanning direction. If the resolution of the main scanning direction of the optical print head 6 is 1200 dpi corresponding to an image formation of A3 size, the length L1 in the main scanning direction of the light-emitting surface 721 is about 21 μm (=25.4 mm/1200). In this case, the light-emitting surface 721 provides 15360 elements in the main scanning direction.

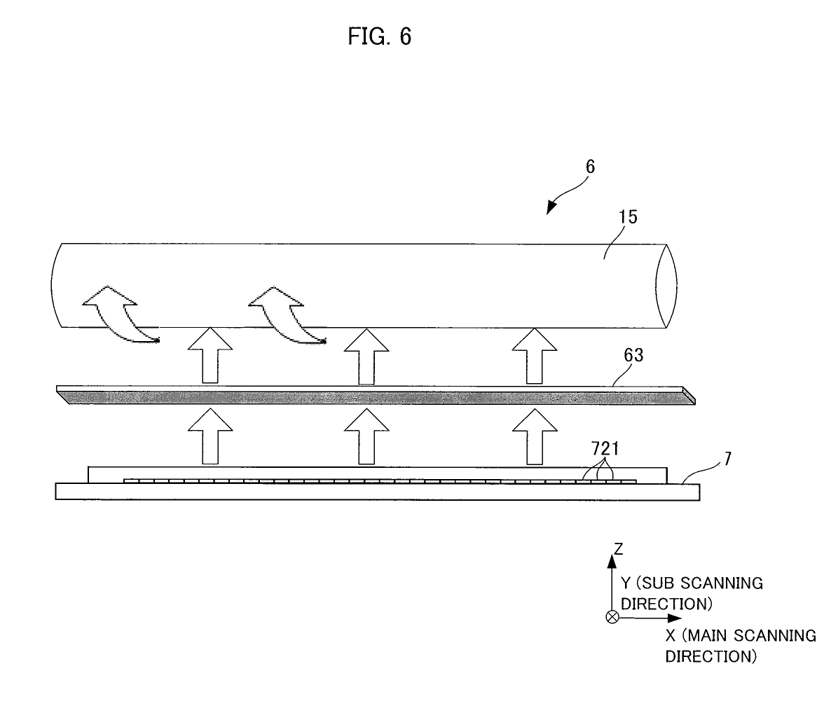

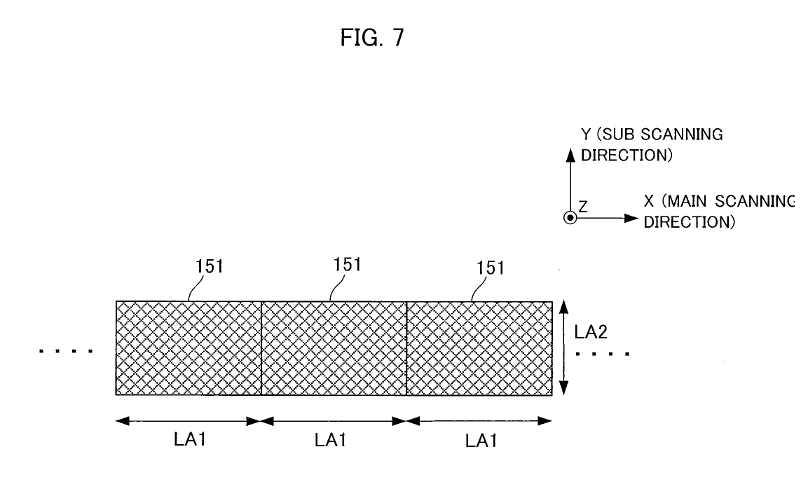

The main control unit 80 controls the light-emitting units 72 so that each the light-emitting surfaces 721 emits light at a predetermined time. As shown in FIG. 6, after light that is output from the light-emitting surface 721 penetrates the SELFOC lens array 63, the image is formed as the spotlight on the photoconductive drum 15 and the photoconductive drum 15 is exposed. As shown in FIG. 7, when the photoconductive drum 15 is stopped, an exposed area 151 on the photoconductive drum 15 due to the emitted light has a shape similar to the light-emitting surface 721, in other words, has the flat rectangular shape in the sub scanning direction. Accordingly, a ratio between a length LA1 in main scanning direction and a length LA2 in the sub scanning direction at the exposed area 151 is the same as a ratio between the length L1 in main scanning direction and the length L2 in the sub scanning direction at the light-emitting surface 721.

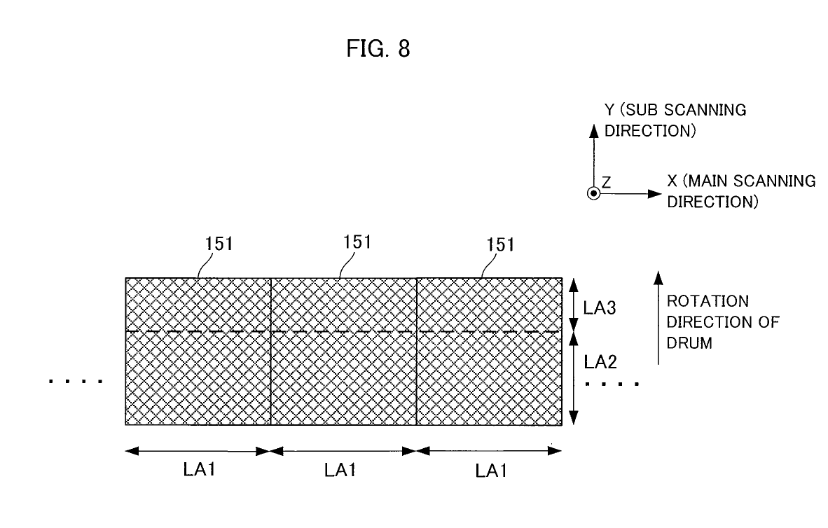

However, in practice, the photoconductive drum 15 rotates while the light-emitting surface 721 exposes the photoconductive drum 15. Thus, as shown in FIG. 8, the exposed area 151 of the photoconductive drum 15 is extended in the sub scanning direction that is a rotation direction of the photoconductive drum 15 and the length in the sub scanning direction is longer as much as LA3. Thus, the length LA1 in the main scanning direction is the same as the length LA2+LA3 in the sub scanning direction at the exposed area 151.

As described above, in the embodiment, the light-emitting surface 721 is a flat rectangular shape in the sub scanning direction so that the exposed area 151 is extended in the sub scanning direction that is the rotation direction of the photoconductive drum 15 and becomes a square shape. Thus, a good image may be obtained. In the embodiment, the light-emitting surface 721 of the light-emitting unit 72 is flat in the sub scanning direction. Thus, if a plurality of the light-emitting units 72 of the embodiment is arranged in the sub scanning direction, the length in the sub scanning direction of the glass substrate 71 may be shortened even slightly. Accordingly, the cost of the glass substrate 71 accounts for high ratio to the cost of the light-emitting panel 7. Thus, if the light-emitting panel 7 in which the plurality of the light-emitting units 72 is arranged in the sub scanning direction is mass produced, the amount of the glass substrate used may be decreased to an amount that creates effects of decreasing of the manufacturing cost. In addition, the light-emitting unit 72 has Organic Electro Luminescence such that the light-emitting unit 72 may be easily formed in order to form the light-emitting surface 721 in a rectangular shape.

In addition, in the embodiment, when the photoconductive drum 15 is stopped, a ratio between the size of the exposed area 151 and the size of the light-emitting surface 721 is 1:1 (L1=LA1 and L2=LA2). When the resolution of the optical print head 6 is 600 dpi, the length L2 in the sub scanning direction of the light-emitting surface 721 is set such that the length LA2+LA3 in the sub scanning direction of the exposed area 151 is 42.3 μm in a predetermined light-emitting time (a basic driving frequency) of the light-emitting surface 721 and at a predetermined rotation speed of the photoconductive drum 15. When the resolution of the optical print head 6 is 1200 dpi, the length L2 in the sub scanning direction of the light-emitting surface 721 is set such that the length LA2+LA3 in the sub scanning direction of the exposed area 151 is 21.15 and the exposed area 151 is a square shape.

In addition, the memory 81 (FIG. 4) correlates and stores the rotation speed of the photoconductive drum 15 and the light-emitting time of the light-emitting surface 721. When there are a plurality of printing modes (for example, color mode or monochrome mode) in which the rotation speeds of the photoconductive drums 15 are different to each other, the memory 81 correlates the rotation speed of the photoconductive drum 15 and the light-emitting time and stores them per each printing mode. The light-emitting time is set to time such that the exposed area 151 is the square shape. The main control unit 80 obtains the rotation speed of the photoconductive drum 15 and the light-emitting time of the light-emitting unit 72 that corresponds to the rotation speed from the memory 81. In addition, the main control unit 80 controls the photoconductive drum 15 and the light-emitting unit 72 based on the rotation speed and the light-emitting time.

Further, the memory 81 stores a command value of the light amount according to a condensing efficiency of the SELFOC lens array 63 and deviation of the light-emitting amount in each of the light-emitting units 72. The command value of the light amount is a command value that specifies the light-emitting amount of each of the light-emitting units 72 and is set to a value that is larger than that of the image forming apparatus of the related art where the shape of the light-emitting unit 72 is the square shape. Accordingly, in the embodiment, even though the shape of the light-emitting unit 72 is flat, each the light-emitting units 72 sufficiently exposes the photoconductive drum 15.

### Second Embodiment

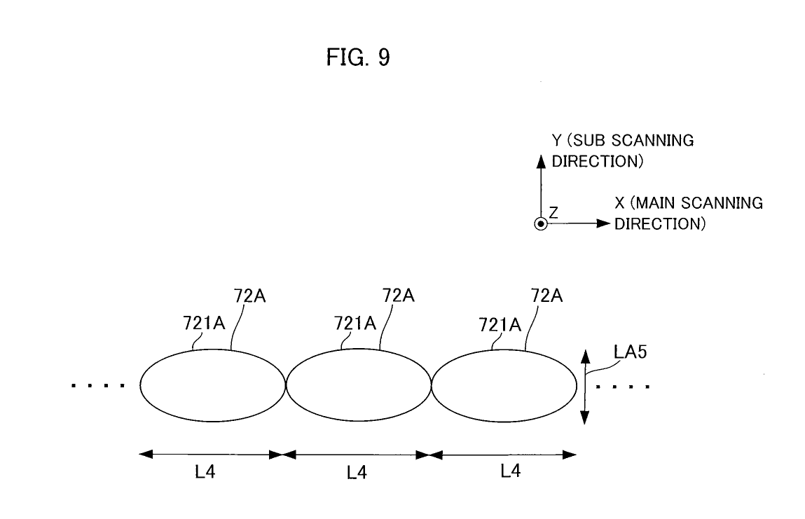

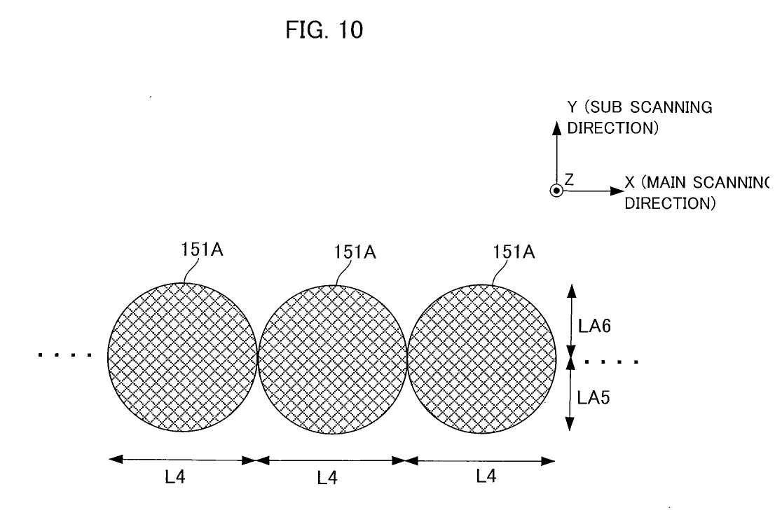

FIG. 9 is a drawing illustrating a shape of a light-emitting surface 721A of each of light-emitting units 72A. FIG. 10 is a drawing illustrating a shape of each of exposed areas 151A.

In the embodiment, the light-emitting surface 721A of the light-emitting unit 72A has an elliptical shape that is extended in the main scanning direction. In other words, the light-emitting surface 721A has the elliptical shape of which a length L5 in the sub scanning direction is shorter than a length L4 of the main scanning direction and which is flat to the sub scanning direction. Further in the embodiment, similar to the first embodiment, when the photoconductive drum 15 is stopped, a ratio between the size of the light-emitting surface 721A and the size of the exposed area 151A is 1:1.

In the embodiment, the shape of the light-emitting surface 721A is the elliptical shape that is flat in the sub scanning direction. However, as shown in FIG. 10, the exposed area 151A is extended in the sub scanning direction that is the rotation direction of the photoconductive drum 15 and the length in the sub scanning direction is longer as much as LA6. As a result, in the embodiment, the exposed area 151A may be a circular shape in which the length L4 in the main scanning direction is the same as the length LA5+LA6 in the sub scanning direction and good image quality may be obtained.

### Third Embodiment

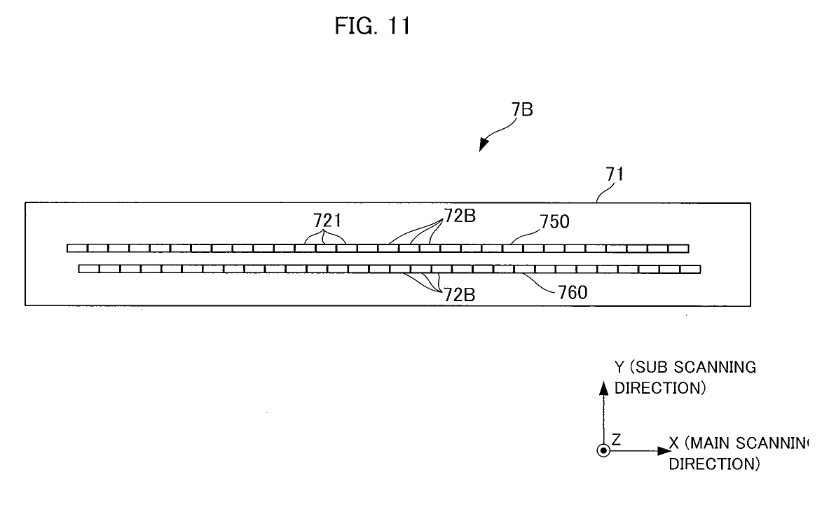

FIG. 11 is a plan view illustrating a light-emitting panel 7B.

In the embodiment, a plurality of light-emitting units 72B is arranged in line in the sub scanning direction with a first row 750 and a second row 760. The first row 750 and the second row 760 are out of alignment in the main scanning direction. The embodiment is the same as the first embodiment at the point that the light-emitting surface 721 of each of the light-emitting units 72B is the rectangular shape that is flat in the sub scanning direction and the exposed area 151 is the square shape.

### Modified Example

The ratio between the size of the light-emitting unit and the size of the exposed area may be 1:1 and may not be 1:1. For example, the size of the exposed area may be larger or smaller than the size of the light-emitting surface.

The glass substrate may not be transparent and may be colored in a case of a bottom emission type in which the light-emitting unit emits light to the glass substrate side.

In the above-described each embodiment, the light-emitting unit 72 has Organic Electro Luminescence, however the light-emitting unit may be a Light Emitting Diode or have an Inorganic Electro Luminescence.

The optical print head is configured such that the light-emitting unit may not have Electro Luminescence and the light-emitting unit (the light-emitting surface) may be each pixel of a liquid crystal. In the case, the optical print head controls each pixel (liquid crystal shutter) of the liquid crystal and the light from the light source is penetrated or not penetrated by each pixel of the liquid crystal so that the photoconductor is exposed.

The sheet may be a sheet that is used in OHP (Overhead Projector).

While certain embodiments have been described, these embodiments have been presented by way of example only, and are not intended to limit the scope of invention. Indeed, the novel apparatus, methods and system described herein may be embodied in a variety of other forms; furthermore, various omissions, substitutions and changes in the form of the apparatus, methods and system described herein may be made without departing from the spirit of the inventions. The accompanying claims and their equivalents are intended to cover such forms or modifications as would fall within the scope and spirit of the inventions.

What is claimed is:

1. A light-emitting panel comprising:
a substrate extended in a first direction; and
a plurality of light-emitting units that is in line in the first direction on the substrate and has a light-emitting surface of which a length of a second direction that is orthogonal to the first direction is shorter than a length of the first direction.

2. The panel according to claim 1,
wherein the substrate is a glass substrate.

3. The panel according to claim 1,
wherein the light-emitting unit is Electro Luminescence.

4. The panel according to claim 1,
wherein the light-emitting surface comprises an elliptical shape that is extended in the first direction.

5. The panel according to claim 1,
wherein the light-emitting surface comprises a rectangular shape that is extended in the first direction.

6. The panel according to claim 1,
wherein the light-emitting panel includes a liquid crystal panel, and
wherein the light-emitting surface is a pixel of the liquid crystal panel and comprises an elliptical shape that is extended in the first direction.

7. The panel according to claim 1,
wherein the light-emitting panel includes a liquid crystal panel, and
wherein the light-emitting surface is a pixel of the liquid crystal panel and comprises a rectangular shape that is extended in the first direction.

8. The panel according to claim 1,
wherein the plurality of light-emitting units is arranged in a first row and a second row that are in line in the second direction, and
wherein the first row of the light-emitting unit is out of alignment with the second row of the light-emitting unit in the first direction.

9. An optical print head comprising:
a substrate extended in a first direction,
a plurality of light-emitting units that is in line in the first direction on the substrate and comprises a light-emitting surface of which a length of a second direction that is orthogonal to the first direction is shorter than a length of the first direction, and
a lens array that guides light emitted from the light-emitting unit to an exposure position.

10. The head according to claim 9,
wherein the substrate is a glass substrate.

11. The head according to claim 9,
wherein the light-emitting unit is Electro Luminescence.

12. The head according to claim 9,
wherein the light-emitting surface comprises an elliptical shape that is extended in the first direction.

13. The head according to claim 9,
wherein the light-emitting surface comprises a rectangular shape that is extended in the first direction.

14. The head according to claim 9,
wherein the plurality of light-emitting units is arranged in a first row and a second row that are in line in the second direction, and
wherein the first row of the light-emitting unit is out of alignment with the second row of the light-emitting unit in the first direction.

15. An image forming apparatus comprising:
a substrate extended in a first direction;
a plurality of light-emitting units that is in line in the first direction on the substrate and comprises a light-emitting surface of which a length of a second direction that is orthogonal to the first direction is shorter than a length of the first direction;
a lens array that guides light emitted from the light-emitting unit to an exposure position;
a photoconductor that is exposed by light emitted from the light-emitting unit, and
a developing unit that supplies toner to the photoconductor and then forms a toner image onto the photoconductor.

16. The apparatus according to claim 15,
wherein the substrate is a glass substrate and the light-emitting unit is Electro Luminescence and is formed on the glass substrate.

17. The apparatus according to claim 15,
wherein the light-emitting surface comprises an elliptical shape that is extended in the first direction.

18. The apparatus according to claim 17,
wherein the photoconductor is a rotating photoconductive drum, and
wherein the image forming apparatus includes,
a memory that stores a light-emitting time when the light-emitting unit forms an exposed area of which the length of the first direction is the same as the length of the second direction at the photoconductive drum while the photoconductive drum rotates, and
a control unit that obtains the light-emitting time from the memory to emit light from the light-emitting unit based on the light-emitting time.

19. The apparatus according to claim 15,
wherein the light-emitting surface comprises a rectangular shape that is extended in the first direction.

20. The apparatus according to claim 19,
wherein the photoconductor is a rotating photoconductive drum, and
wherein the image forming apparatus includes,
a memory that stores a light-emitting time when the light-emitting unit forms an exposed area of which the length of the first direction is the same as the length of the second direction at the photoconductive drum while the photoconductive drum rotates, and
a control unit that obtains the light-emitting time from the memory to emit light from the light-emitting unit.
